(19) United States
(12) Patent Application Publication
(10) Pub. No.: US 2004/0120706 A1
(43) Pub. Date: Jun. 24, 2004

(54) Fault isolation in agile transparent networks

(76) Inventors: Kerry Johnson, Kanata (CA); Peter David Roorda, North Ottawa (CA); Kim Letkeman, Nepean (CA); Paul Jean, Ottawa (CA); Jeffrey Kenneth Emery, Ottawa (CA)

Correspondence Address: Norman P. Soloway, HAYES SOLOWAY P.C., 130 W. Cushing Street, Tucson, AZ, 85701, US

(21) Appl. No.: 10/325,010

(22) Filed: Dec. 20, 2002

(51) Int. Cl. H04B 10/08

(52) U.S. Cl. 398/10; 398/17

(57) ABSTRACT

The first step in isolating a soft fault within a transparent network is to determine which OMS trail is causing the fault. This can be accomplished by forcing regeneration at a flexibility point, which permits the estimation of the signal quality using a BER measurement. The preferred mechanism for segmenting Och faults to an OMS/trail is eavesdropping, using dedicated tunable filters and receivers or spare test tunable filters and receivers at network flexibility sites. Once the fault has been isolated to a specific OMS trail, analog tools are used to further isolate the fault down to a single replaceable module or fiber, using rapid measurement and correlation of relevant measured and pre-calculated expected performance data. In case of hard faults, to avoid superfluous alarm reports at connection termination points, the optical channel fault detector provides fault indications to downstream nodes using Forward Defect Indications (FDI) over the optical supervisory channel (OSC). In all instances, the fault isolation requires knowledge of the network topology and relationship between topology and OAMP data.

### RELATED PATENT APPLICATIONS

U.S. Patent Application, “Architecture For A Photonic Transport Network”, (Roorda et al.), Ser. No. 09/876,391, filed Jun. 7, 2001, docket 1001 US;

U.S. Provisional Patent Application “Method for Engineering Connections in a Dynamically Reconfigurable Photonic Switched Network” (Zhou et al.), S No. 60/306,302, filed Jul. 18, 2001; formal patent application Ser. No. 10/159,676, filed May 31, 2002, docket 1010US; and

U.S. Patent Application “Network operating system with topology autodiscovery” (Emery et al) Ser. No. 10/163,939, filed on Jun. 6, 2002, docket 1015US.

These patent applications are incorporated herein by reference.

### FIELD OF THE INVENTION

The invention resides in the field of optical telecommunications networks, and is directed in particular to ways of isolating faults in agile transparent networks.

### BACKGROUND OF THE INVENTION

The drive to reduce backbone network cost has been the catalyst for many advances in optical networking technologies. Over the past 5-7 years, improvements in system reach through enhanced modulation schemes and optical amplification have led to ultra long haul (ULR) systems capable of transporting wavelengths thousands of kilometers.

Current DWDM (dense wavelength division multiplexed) networks constructed with point-to-point line systems provide the ability to monitor wavelengths at all switching nodes (interconnect points), since each wavelength is electrically terminated. This approach, however, introduces unnecessary cost into the network since the majority of wavelengths are merely reconnected to another line system through back-to-back opto-electronic converters.

Recent advances in photonic switching have enabled transparent DWDM networking. Migrating to a transparent network architecture that supports end-to-end wavelength networking and removing unnecessary optical-electrical-optical (OEO) conversions at the switching nodes results in network cost savings as significant as 40-50%. Adding full spectrum tunable sources and filters provides significant operational savings and offers a new level of flexibility and DWDM provisioning speed. These capital and operational savings and speed of connection activation are key attributes of next generation agile networks.

In both opaque and transparent networks, the key goal remains the same: detection of degradation of transmission as soon as it occurs and isolation of the fault to its root cause. In order to provide timely resolution to performance degradations, carriers require methods to quickly isolate faults to a single fiber span or replaceable module.

While the capital savings alone provide a compelling reason to minimize OEO conversions in the network, one of the drawbacks commonly attributed to transparent networking is that it limits fault isolation capabilities, since all electronic monitoring points (and their associated costs) are typically only located at network ingress and egress points.

The network faults are classified (ITU G.873) into two broad categories: hard faults and soft faults. Hard faults encompass failures in the physical equipment or medium used to provide the service. Circuit pack failures and fiber cuts are common examples of hard faults. These failures are not transitory in nature, and they require that equipment be repaired or replaced before the service can be restored. In addition, a hard fault point normally detects a circuit pack failure immediately, while a fiber cut is detected when the downstream node sees the loss of light and alarms the resulting condition.

Soft faults, on the other hand, are performance degradations to a service, where an associated hard failure cannot be attributed. Stretched or kinked fibers, degradations due to aging and environmental factors are all examples of soft faults. Soft faults either temporarily interrupt or simply degrade the performance of the service. The main difference between soft and hard faults is that soft faults are detected downstream (sometimes several fiber spans downstream) from where the fault originates, preventing the immediate identification of the root cause of the failure. Advanced fault correlation software is required to determine the root cause.

The general strategy for detection and isolation of soft faults in today's network is to use SONET performance monitoring. The hard faults are detected using protection fibers and the associated protection hardware, together with the SONET line and ring protection protocols (UPSR, BLSR). A soft failure causes a signal to degrade for a non-obvious reason. Signal quality Q degrades to a point where error thresholds are crossed (sending Threshold Crossing Alerts—TCAs), but no hard fault is posted on the same line.

TCAs, when they indicate a noticeable drop in customer throughput or loss of frame LOF, require a craftsperson to spend time chasing down likely failure(s). The lack of a hard fault makes these failures inherently difficult to isolate; the potential causes are quite diverse, and all must be examined and compared in order to make a reasonable diagnosis. The craftsperson must examine all available electrical and optical measurements, current and historical. Each section must be examined; depending on the success of the segmentation process, the line, a section, or a shorter segment will then be examined in further detail. As well, the craftsperson must cross-reference all recent calls with the affected calls, looking for shared paths. In other words, the craftsperson must perform dozens of operations, each of which will take some time.

After some (probably relatively long) period of time, a circuit pack or patch cord may appear faulty, or the path may appear to have degraded from an overloaded link or from unknown causes. Thus, the whole process could take considerable time in traditional networks. In addition, the traditional methods cannot be applied in agile transparent networks, where regeneration (and therefore access to the signal in electrical format) occurs only at the ends of the trail.

There is a need to provide a fault isolation technique for agile transparent networks, where user traffic travels in optical format over long distances, without regeneration at intermediate switching nodes.

There is also a need to automate as much of the failure isolation process as possible and to present filtered information as an aid to the craftsperson.

### SUMMARY OF THE INVENTION

It is an object of the invention to provide an agile transparent network with fault isolation capabilities. Another object of the invention is to automate the failure isolation process for importantly reducing the time a fault is located in an optical network.

The invention is preferably directed to transparent agile networks having a plurality of flexibility points connected over optical fiber links, the network being provided with a distributed control plane that maintains an updated view of network topology and performance data. According to one aspect, the invention provides a fault isolation system for determining a point of failure along an optical channel Och trail in the network, comprising: at an egress terminal of the optical channel Och trail, means for detecting one of a signal degradation alarm and loss of signal alarm, whenever the user signal carried by the channel is subject to a fault; and an optical channel fault detector for determining an optical multiplex section OMS that produced the fault.

According to another aspect, the invention provides a fault isolation system for determining a point of failure along an optical channel Och trail in the network, comprising: at an optical amplifier site, means for detecting an upstream loss of signal alarm LOS and transmitting a forward defect indication FDI; at a first flexibility point downstream from the optical amplifier, a hardware fault monitor for locating a fault that triggered the loss of signal LOS alarm.

Still further, the invention provides a method for fault isolation in optical networks comprising: collecting on-line current performance data at optical device granularity from measurement points; identifying a problem in the network using a fault diagnostic tool; filtering the on-line performance data for the channel trail to provide filtered performance data pertinent to the problem; and isolating the problem based on the filtered data.

An inherent advantage over the typical manual problem isolating is that in the case of soft faults, the system looks at all readings along the entire path in parallel. Therefore, while fault isolation system of the invention reports segmentation to the craftsperson, it always examines the entire path. As well, it automates the process so that fault isolation is performed much faster than traditionally.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates traditional fault sectionalization based on SONET performance monitoring;

FIG. 2 shows the trail of an optical channel in an optical transport network OTN;

FIG. 3 shows a high level view of the distributed control plane with the fault isolation system according to the invention;

FIG. 4A illustrates optical multiplex section fault sectionalization based on eavesdropping according to the invention;

FIG. 4B shows an example of soft fault sectionalization within an OMS;

FIG. 5A is a BER curve for an optical channel trail without impairments;

FIG. 5B is a BER curve for an optical channel trail with component failure impairment; and

FIG. 6 illustrates alarm conditioning with G.872 messaging according to the invention.

### DETAILED DESCRIPTION

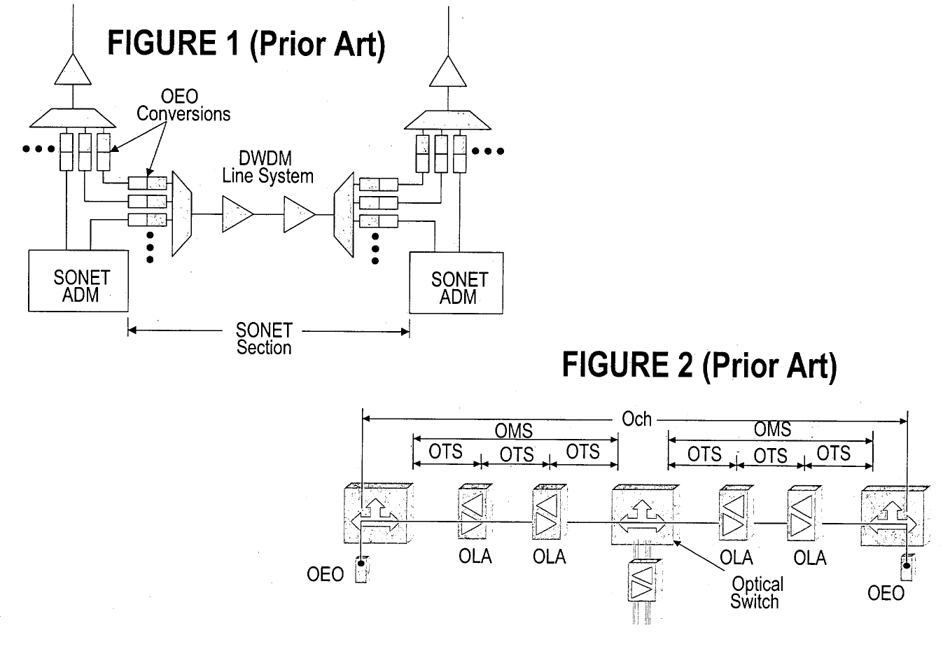

In traditional core networks, SONET fault isolation techniques are used in conjunction with DWDM optical monitoring. With point-to-point DWDM systems, BER and related data such as SONET performance monitoring data are available at line system interconnect points. As shown in FIG. 1, this is possible because back-to-back OEO conversions are performed on each wavelength at each switching node. In the simplified example shown in FIG. 1, there are no intermediate SONET regenerators so the SONET section and line extend between the SONET add/drop multiplexers (ADM). SONET section statistics, computed using the B1 byte in the section overhead, are used at handoff between SONET equipment and the DWDM line system. Each wavelength can be monitored at its endpoint to determine its health.

In cases where a DWDM transport system is used to transport the signal between regeneration points, further fault segmentation is provided using analog measurement tools.

To assist in hard fault isolation, SONET supports Alarm Indication Signal (AIS) and Remote Defect Indication (RDI) maintenance signals to provide upstream awareness of faults and downstream fault indication conditioning. For example, if a fiber cut occurs, it will be immediately detected by the downstream node, which will assert a loss of signal (LOS) alarm indication. In order to squelch symptomatic alarms downstream, the network element detecting the LOS condition will assert an AIS signal in the line overhead. The downstream line termination equipment (LTE) will terminate the incoming line AIS signal and generate the appropriate path level AIS signals. In the case of a unidirectional failure, a RDI message is sent to the upstream nodes to notify them of the failure and to initiate channel conditioning. Generally, the RDI signal is used to facilitate restoration activities in the upstream equipment. From a fault isolation perspective, RDI and AIS provide an indication of the SONET section where the fault occurred.

These SONET mechanisms provide a method to isolate hard faults to a specific section within a SONET line. However, for WDM networks, additional fault isolation at the DWDM layer is required. This is often based on optical loss of power indications at line amplifier sites. Typically, at amplification sites, the quality of the multi-wavelength signal is analyzed using analog measurements such as total received optical power. Generally, this is accomplished by comparing current power readings to a historic baseline value recorded when the system was first commissioned. Reflection measurements are also commonly used in the process of isolating a fault within a DWDM line system. Often in DWDM line systems, the symptomatic downstream alarms are not suppressed and require correlation software or human analysis.

To support dynamically configurable (agile) transparent networking, a number of new capabilities have been introduced into the DWDM layer of the new generation of optical transport networks. Such a network and its new capabilities are disclosed in the above-identified US Patent Applications Docket 1001US, Docket 1010US and Docket 1015US. To summarize, these capabilities include:

1. A distributed control plane that understands network topology and considers photonic properties and constraints for wavelength routing.

2. Full-featured photonic layer network management. The DTS associates the performance and topology data and updates this information so that establishment of each new connection is based on actual performance and topology information.

3. Advanced end-to-end wavelength monitoring and control based on power and gain targets.

4. Tunability. The network is provided with tunable components and the associated controls that enable automatic wavelength selection for routing, switching and monitoring purposes.

5. G.709 Digital Wrapper.

A significant byproduct of these capabilities is a novel, improved fault isolation system. These enablers are briefly described next with a view to explain how fault isolation system on the invention is performed in such a network.

1. Adding wavelengths to, and removing wavelengths from a transparent network require network level coordination to ensure end-to-end performance. This higher-level control function falls into the realm of a distributed control plane. The key functions in the control plane that enable network wide wavelength control are collection and distribution of topology and photonic layer parameters throughout the network. To compute the lowest cost end-to-end connection the control plane must be aware of network topology and photonic properties of the fiber plant and optical components. For example, to assign an appropriate wavelength, the fiber losses and dispersion characteristics for each span must be known and used during wavelength assignment. Also, detailed knowledge of the performance of the optical components associated with the connection, such as noise figure, chirp and dispersion are factored into the photonic engineering logic of the control plane. As a result, automated engineering can adapt to the actual performance of installed components and guarantee performance over the life of all associated wavelength connections.

Network topology autodiscovery capability allows automatic update of the topology whenever a new device is added or replaced with another version, or a device is pulled out. Topology information is accessed by the interested network entities through a distributed topology system DTS.

2. To enable best route selection for a service, the wavelength control system provides insight into wavelengths performance and access to the device specifications and device performance monitors. In addition, automated commissioning provides measurements of the actual photonic parameters of the network and allows calculation of target operational parameters. This visibility is enabled by provision of monitoring points connected to optical spectrum analyzers OSA; an OSA module is time-shared so that it collects photonic properties from a plurality of monitoring points (e.g. 8). Embedded (in-skin) network performance monitoring and topology autodiscovery capabilities enable full-featured photonic layer network management, allow maximizing network performance and also enable enhancements and further intelligence to be added without directly impacting the stability of the network.

Furthermore, embedded measurement capability and embedded performance data in each component can be used to provide an expected performance for each connection. Significant deviations from this expected value indicate the potential for soft faults. An audit that follows the optical path quickly compares all of these performance criteria against measured values to show points in the network at which components are operating in the margins, a potential cause of soft failures.

3. Transparent wavelength networking also introduces a number of challenges for DWDM control system software. To effectively support arbitrary length optical paths introduced by differing wavelength ingress and egress points, intelligent optical control loops are needed in both the line system and transparent switch. Line control loops manage gain profiles as wavelengths are added or removed from the line segment. These control loops are needed to control Raman gain, EDFA tilt and dynamic gain equalization. Advanced line control methods require strategic monitoring taps and per channel feedback through the OSAs. At wavelength endpoints and switching points, control loops are required to control per-wavelength power launched into the line and delivered to the transceivers. Again these control techniques require monitoring taps and per channel feedback through an OSA.

6. One of the most important characteristics of the agile network to which the invention applies is tunability. Thus, since channels are dropped and new channels are added at arbitrary moments of time, the number and wavelength of the channels on each line and at each node varies accordingly in time. To make possible this functionality, the network is equipped with tunable components such as tunable transmitters, tunable filters, blockers, dynamic gain equalizers that enable wavelength selection and routing in the access subsystem, individual wavelength switching and add/drop at the nodes, dynamic control of the line system, and wavelength monitoring throughout the network.

5. To contend with the long transmission paths necessary for transparent networking aggressive forward error correction (FEC) is used. To provide FEC, incoming signals are framed in an ITU G.709 based digital wrapper. This wrapper contains many features, described below, that are relevant to fault segmentation and isolation. These features can be accessed wherever an OEO conversion is performed in the network.

The FEC overhead and BIP-8 parity bytes facilitate signal monitoring with measurements similar to SONET, such as code violations, errored seconds and severely errored seconds. These measurements provide a detailed indication of signal quality. When this is combined with the “optical eavesdropping” technique described above, performance degradations can be isolated to a single multiplex section between optical switching sites.

Another special feature of the digital wrapper overhead is the support for tandem connection monitoring. This permits the operator to define the section to be monitored instead of being restricted by the SONET section/line/path hierarchy.

Digital wrapper trail trace—monitoring performs a function similar to that provided by the path trace byte in the SONET overhead. The trail trace overhead can be correlated with expected values to ensure that the signal is following the expected path.

In order to understand how the system of the invention operates, it is also important to explain some terminology that is used in the transparent network. As defined in ITU G.872, optical networks contain several layers just like SONET networks. FIG. 2 shows the relationship between these layers. At the “path” level, optical networks support Optical Channels (Och), which track each wavelength channel from where it originates shown be the electrical to optical conversion at 110, to where it exits, shown by the optical to electrical conversion at 120. Similar to the “line” concept in SONET, the Och layer is composed of many optical multiplex section trails (OMS). Optical multiplex sections (OMS) are delimited by locations where the signal is multiplexed or switched into other line systems. The OMS layer is composed of several optical transport section (OTS) trails. These represent the physical medium that is used to transport the optical signal between network elements in the OMS.

All soft failures are, by definition, subtle enough to escape detection as a hard failure, which means that they are inherently hard to find. As described earlier, isolating a soft fault in a traditional DWDM line system can be a complicated and time-consuming task, since it requires the user to compare the current power measurements to historical baseline values. Using this technology to troubleshoot a fault in a long haul transparent system could be difficult, since path lengths can span thousands of kilometers without electrical monitoring points.

In principle, the soft faults may be classified as operational failures and partial component failures. Operational failures are for example triggered by environmental changes (temperature, PMD), additional load (a new connection set-up) causing wavelength interaction, or long-term deterioration in component performance. Also, setting thresholds too low could be considered an operational fault. Partial component failures are for example faults at circuit pack, patch cord, plant fiber level that may fail in such a way that it is difficult to detect as an outright failure (a patch cord might be pinched, nicked or dirtied during maintenance with resulting increased reflection, distortion and/or loss).

In a transparent network, a soft fault is indicated by a threshold crossing alert on the Och trail at the OEO point where the signal exits the network (a signal degraded alarm). From this, all portions of the Och trail are suspect. The first step in isolating the fault is to segment the fault to an individual OMS trail. The next step is to isolate the OTS trail within the OMS trail that contains the fault using optical power and reflection readings. This can be accomplished using traditional tools, but the new fault isolation system according to the invention will dramatically reduce the amount of time required by the traditional processes. Hierarchical transparent switching, where interconnection between the line system and switching node is performed at the multiplex level, provides a single point where all incoming wavelengths can be monitored. A simple power tap on the multiplexed line at the switch input port provides access to all wavelengths on the line. Since the test access port (a monitoring tap) is a power split, this monitoring can be done in a non-intrusive fashion.

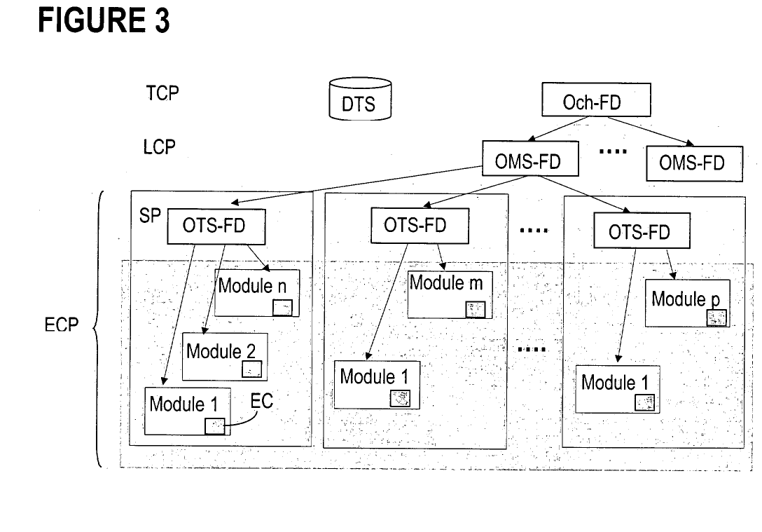

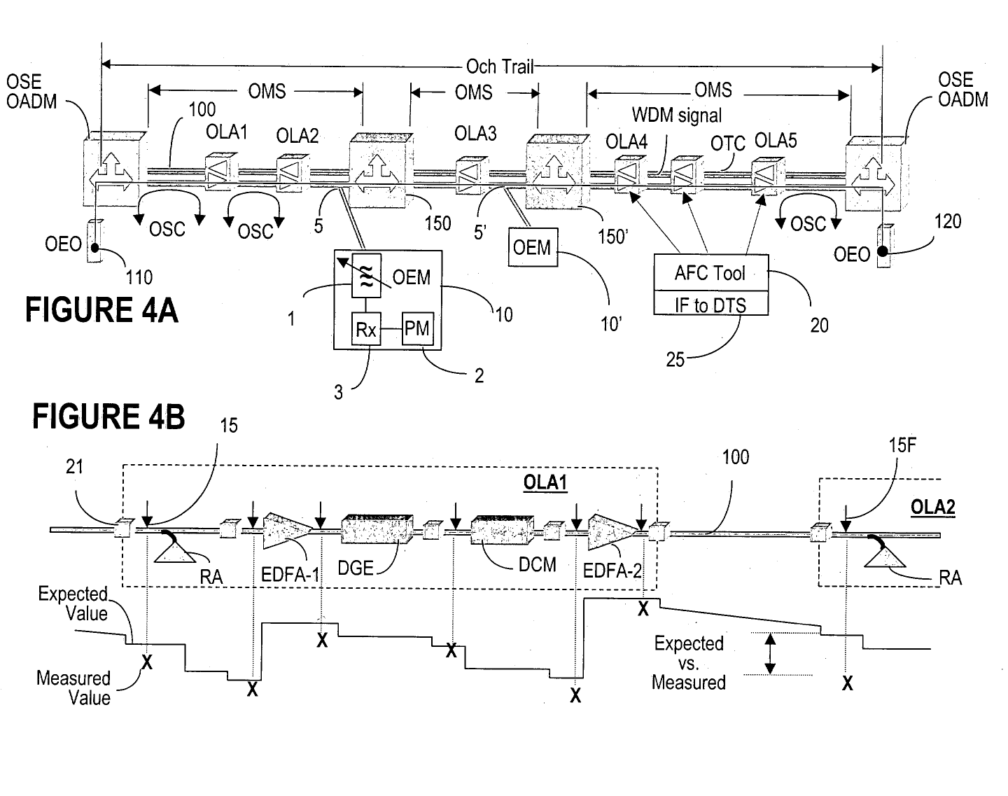

FIG. 3, which show a high level view of the distributed control plane with the fault isolation system according to the invention is described in conjunction with FIGS. 4A and 4B, which illustrate soft fault sectionalization based on eavesdropping and the analog tools according to the invention.

To summarize what is described in the above-identified co-pending patent applications, the optical devices of the agile network are connected over an optical trace channel OTC, shown in FIG. 4A, that follows all the fiber connections between the optical components along each possible path within the network. OTC allows network entities to report hierarchically their identity and their neighbors so that the DTS maintains an updated view of the network topology and connectivity. In the preferred embodiment, the traces are provided as 1310 nm signals, and can be communicated on tandem fibers, or multiplexed onto the same fiber as the traffic-carrying wavelengths.

The agile network also uses an optical supervisory channel OSC, as shown in FIG. 4A, for transmitting the service information necessary for proper operation of the line system and switching nodes. The OSC is preferably a POS (packet over SONET) that operates at OC-3 rate, embedded on the WDM fiber over a wavelength of 1510 nm. The OSC is coupled/decoupled at the optical amplifier modules; the switching/OADM nodes at the ends of a link are provided with packet routing capabilities.

FIG. 3 shows an embedded control plane ECP, which operates at the module level and at the shelf level, to monitor performance and control operation of the modules that make-up the network. Most modules (e.g. Raman modules, EDFA modules, DCMs, et) in the agile network use a standard card equipped with an embedded controller EC and with the respective optical devices that make the card and the module specific. Each EC sets the control targets for the respective optical module, reads run-time data and intercepts asynchronous events. All shelves are provided on a standard backplane equipped with a shelf processor SP and the respective modules that make the shelf specific. Each SP coordinates the actions of various optical devices in the shelf. For example, in the case of an optical line amplifier, the SP operates a Raman, an EDFa and a DCM module as a group, to achieve a control objective for the group as a whole. The SPs are equipped with means for isolating a fault in the respective group of modules, shown by the optical transport section fault detectors OTS-FDs. Each SP manages and controls the respective embedded domain over a shelf network, and provides an interface with the link control plane LCP. The OTS-FD enables isolating a soft fault to a segment of the OTS (e.g. a module or a group of modules, a fiber span, etc) using soft fault isolating tools as seen later.

At the line level of control, (the line is the portion of the network between two successive switching/OADM nodes) namely the line control plane LCP, an optical multiplex section fault detector OMS-FD is responsible with periodic link channel monitoring and link channel quality testing. Quality testing is performed for example during light-path setup, when the quality of each channel is measured at the ends of each link to ensure that their performance exceeds a pre-defined margin. The pre-defined margin consists of a system margin and a wavelength-loading margin, which accounts for the number of co-propagating channels. Details on these margins and how path monitoring and maintenance are performed are provided in the above-referenced US patent application Docket 1010US. The OMS-FD enables isolating a soft fault to an OTS using soft fault isolating tools as seen later.

At the trail control plane TCP, an optical channel fault detector Och-FD monitors and tests the quality of an end-to-end optical channel. FIG. 3 shows the distributed topology system DTS at this level. As indicated above, the DTS (shown generically as a database), administers the OAMP, topology and connectivity information. The OAMP information is cross-referenced with the topology information in the management information base MIB of the agile network to enable control of performance of each end-to-end connection. Thus, current and historic device performance and state data, call set-ups, device specifications, together with monitoring data are collected, stored, updated and accessed by the DTS, over interfaces provided at all control levels. The Och-FD enables isolating a soft fault to an OMS using soft fault isolating tools, and also enables isolating hard faults.

Soft Fault Isolation

In certain operating scenarios, a dirty fiber and some specific component failures will be difficult to detect as a hard failure. Instead, these degradations will become visible when the signal is converted back into an electrical format. The signal BER will rise and cross a preset threshold, asserting a TCA (Threshold Crossing Alert). This scenario is the perfect candidate for a soft fault isolation tool. According to the invention, a soft fault is first detected at the egress terminal of a channel using TCA, then is further isolated to an OMS using optical eavesdropping, and further down to an OTS and a network segment using advanced fault correlation toos. Soft fault isolation primary strategy is to provide assistance to the craftperson as soon as a first threshold crossing alarm TCA is posted, making suggestions as information settles into one or more potential diagnoses. This strategy cuts a great deal of time from the resolution of soft failures, as the system reacts to even slightly poorer performance, whereas the craftsperson will always apply some level of judgment as to whether the amount of degradation is worth the pain of the manual isolation process. In addition, by the time the craftsperson has decided that a problem exists, the fault isolation system posts a list of potential failures, and the shortest segment that appears to contain a problem.

Thus, on receipt of the first TCA/LOF for the path, as provided by a respective FEC-enabled receiver, there are several steps to soft fault isolation. Each step may overlap another in time. Some are fully distributed, being performed on every entity (circuit pack, shelf and/or controller) that owns a part of the faulty path. If the alarm is a TCA, soft fault isolation begins immediately, if not, soft fault isolation waits for a protection switch. If a hard fault occurs at any point along the respective Och trail, any soft fault isolation activity stops.

The next step is to isolate the problem to the OMS trail and further down to a segment that is causing the fault. This step requires acquisition of performance data for the entire Och trail, acquired in various measurement points. Once the data is collected, the faulted shortest segment that is affected by the fault is isolated by intersection, examination and evaluation of the data available for the respective OMS segment. These operations are executed in parallel on the OMSs of the affected Och trail, starting preferably with the last (downstream) OMS, and all results are stored in the DTS. These measurements may be used directly, when for example they are compared to a threshold, or compared with an adjacent reading of the same type. The measurements may also be compared with previous values from the same device.

One mechanism to isolate a soft fault to an individual OMS trail is to force regeneration at a flexibility point along the respective trail. This is possible in an agile network with selective regeneration as disclosed in the above-identified co-pending patent applications. When this forced signal regeneration occurs, an OEO conversion takes place, which permits the estimation of the signal quality using a BER measurement. However, this mechanism has two drawbacks. First, forcing regeneration disrupts the existing signal path. Second, adding regeneration into a signal path increases the overall cost of the circuit as described in the abstract.

The preferred mechanism for segmenting Och faults to an OMS trail is “eavesdropping”, as shown in FIG. 4A. Eavesdropping uses spare/dedicated tunable filters and receivers at network flexibility sites. The advantage of this technique over forced regeneration is that the signal monitoring is non-intrusive to the existing service.

Each optical eavesdropping monitor OEM 10, 10′ taps a fraction of the optical WDM signal on each fiber 100 at the input side of a switching/OADM node 150, 150′, as shown by monitoring taps 5, 5′. This tapped optical signal is connected through a tunable filter 1 to a receiver Rx 3 to select a specific wavelength (that of the faulted channel) from all the wavelengths present on the respective fiber. From this point, the signal can be monitored in the digital domain, as shown by the receiver's performance monitor PM 2, which provides the same diagnostic capabilities as an OEO conversion point between line systems in a point-to-point DWDM network. For example, the PM 3 estimates the BER of the originating bearer channel. Eavesdropping uses spare tunable filters and receivers or dedicated test tunable filters and receivers at network flexibility sites.

Collection of BER readings at the OMS and Och levels is supported by the digital wrapper capabilities. The fault isolation system of the invention may organize this monitoring data in performance bins maintained for example for 15 minutes, 24 hours or for ‘on request’ period of time. Such bins could for example store code violation (CV) data, errored seconds (ES) data, severely errored seconds (SES), and severely errored framed seconds (SEFS) carried respectively by the digital wrapper line and section, and pre/post FEC bit error rate (BER) for FEC section. It is to be noted that for an end-to-end service that includes the access part to the agile core network to which the invention applies, this data is carried in the SONET frame for example.

These bins have associated thresholds, and a threshold crossing alert (TCA) is sent immediately upon a violation. The optical channel fault detector Och-FD immediately looks for a reason for the TCA. Multiple TCAs on the same line or section will follow a specific masking order such that the most severe TCA will be addressed. LOF will cause a protection switch; the fault system will react by becoming more aggressive with its testing.

At the optical multiplex section OMS level, the faults are isolated down to a single replaceable module or fiber, based on the current and previous power measurement provided by the device's performance monitors. As described previously, manual comparison of the current power readings to “baseline” power readings was the traditional method for fault isolation. While effective, this could be quite a lengthy arid time-consuming task. The key to rapid detection and isolation to an OTS trail is the rapid measurement and correlation of relevant power measurements. These features are packaged into an advanced fault correlation AFC tool 20 that follows the trail in question, reading all relevant analog and digital performance measurements on the selected channel and compare them to the expected values to detect unusual system events. Unusual readings are automatically flagged for the operator's attention. AFC 20 uses performance monitoring data collected in various measurement points 15 of the respective OMS, the intra-sectional BER readings obtained by eavesdropping, together with per channel and component current and historic data and stored initial data, and potentially analog readings. From this data, the current system health can be judged and failures can be isolated.

First the tool locates all of the relevant data for the monitoring points 15 along the respective OTS, and next, it automatically compares them to their expected value. The AFC tool 20 pre-calculates the expected values loss between monitoring points based on the components, connectors, and fibers used. For example, in the case of the portion of a transmission line including an optical line amplifier OLA1 and the next optical line amplifier OLA2, as shown in FIG. 4B, monitoring points 15 could be provided at the input of each module making the OLAs, namely a Raman module RA and two Erbium doped fiber amplifier stages EDFA-1 and EDFA-2, with a dispersion compensation module DCM and a dynamic gain equalizer DGA connected between the EDFA stages. The pre-calculation of the expected loss enables automatic identification of potential problem spots within the OMS trail. In such a point, denoted in the example of FIG. 4B with 15F, the measured loss is much higher than the expected loss, so that the problem can be attributed to the fiber between the OLA1 and OLA2. In this way, problem spots can then be brought to the users' attention.

The fault isolation system operates to isolate the shortest possible segment(s) from all available historical data for matching measurement points 15, recent call setup and recent threshold changes. In sequence from egress to ingress, AFC tools direct tests on all entities of interest (circuit packs, patch cords, etc.). Because some tests may be intrusive, or even disruptive, the tests are first performed towards the end of the path to keep the light-path as similar as possible to the faulty condition for each test, i.e. to keep any intrusion isolated to already tested components if possible. All the test results obtained by juxtaposing, contrasting, and comparing current performance with historic performance, for recent thresholds and recent call set-ups are used to create an ordered and weighted list of potential failures. The results are stored in the DTS.

As seen above, the digital wrapper line and section data performs a critical role in detecting the soft fault by providing the. BER measurements that are compared to thresholds. Loss and distortion are the strongest components affecting Q, and therefore are discussed next by way of example. Loss is further affected by all characteristics of the light-path, including routing, electronics, wavelengths, fiber type, and circuit length. Attenuation and bandwidth are the key parameters for loss budget analysis. The Q estimate that is produced as calls are dialed relates directly to the raw BER that will be experienced on the path. Both passive and active components of the circuit are included in a loss calculation. Passive loss is made up of fiber loss, connector loss, and splice loss (including couplers and splitters). Active components are system gain, wavelength, transmitter power, receiver sensitivity, and dynamic range. Traditionally, a loss budget is used to insure that network equipment will work over a newly installed fiber optic link. Traditional link budget are quite conservative over the specifications, in order to avoid using the best possible specifications for fiber attenuation or connector loss.

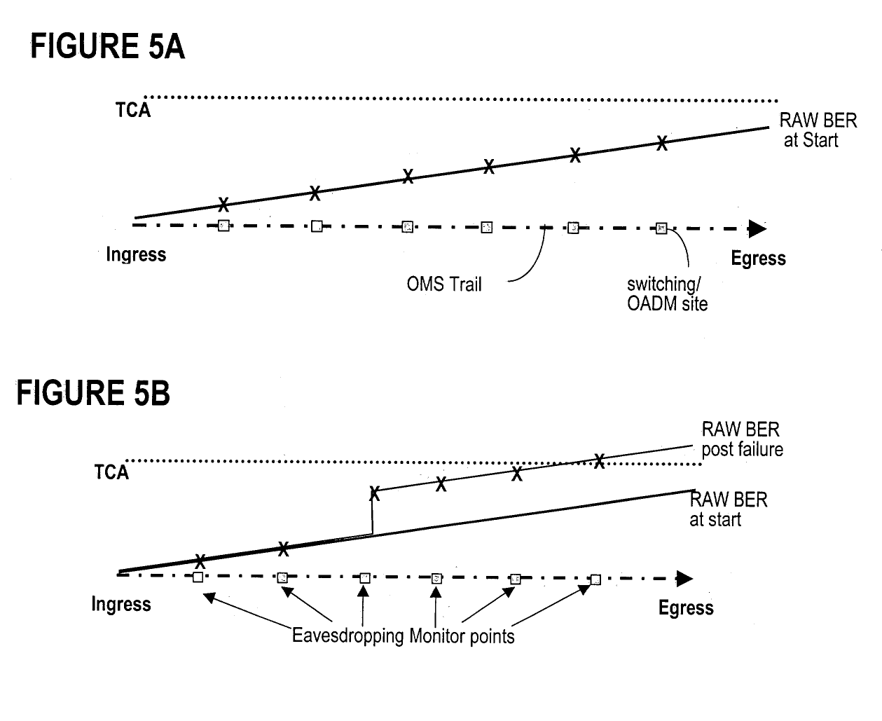

On the other hand, the flexible and dynamic nature of the agile network to which the invention pertains, enables more aggressive loss budgets. The ability to “eavesdrop” provides measurements for each OMS trail. The optical channel fault detector OchFD collects all measurements for the OEMs 10 provided along the respective trail, to assemble a BER graph as shown in FIG. 5A. In this example the signal BER is collected from eight different monitoring taps along the signal path (two endpoints and six intermediate points). Each monitoring tap represents a switching or OADM node, with OMS trails interconnecting the sites in the network. It can be seen that as the loss accumulates, OSNR (Optical Signal to Noise Ratio) degrades and the raw BER grows. Optical amplification (more precisely the Raman amplifier of hybrid Raman-EDFA amplifiers) improves OSNR slightly, but not much more than a connector's worth. BER accumulates to the point where the network provides automatic regeneration so that, in order to complete the path successfully, the BER remains below the threshold that triggers a TCA event. Nonetheless, the Och FD periodically captures all of these readings for future reference.

When, for example, a new call is added to the network, and a high-load link suddenly suffers from wavelength interaction, the slope of the BER curve is expected to remain unchanged everywhere except on a shared section (link). The OMS FD for the affected section takes into account the possibility that the wavelength interaction introduces distortions that carry through the rest of the line, causing an increase in BER slope all along the rest of the trail. In a component failure scenario, the failure causes a degradation of the signal, thus causing BER to rise at egress, and a TCA to be raised. Provisions are made for these and environmental changes (e.g. temperature), long term component deterioration, etc. using margins.

As shown in the example of FIG. 5B, the degradation occurs between the second and third monitoring points, thus dramatically increasing the overall BER of the signal. This measurement is compared to historical values to determine the OMS trails of interest. In this example, the fault isolation software notes a sudden increase in the BER between the second and third monitoring points.

The fault isolation system of the invention always reports the shortest segment(s) that do not read perfectly at their endpoints. Although it can quickly isolate a section on raw BER readings as shown throughout this document, it may be equally valid to isolate segments on other metrics, hopefully resulting in shorter faulty paths on which the craftsperson may concentrate. Another form of shortest faulty segment exists where a single circuit pack cannot be isolated. Instead, a small group of circuit packs will be tested where appropriate metric capability exists.

It is to be noted that BER slope as shown in FIGS. 5A and 5B is an example of how to isolate a section affected by a fault. This parameter may be used in the case when the distance between the monitoring points 5 is known. If not, the Och-FD can use the difference between points as a baseline and assume that the slopes are similar. As long as BER is always measured at the same points in the network, the slopes between any two points can stand alone. The slopes may also be compared with previous values for the same segment. In other words, the slopes are merely a convenient way to isolate a large change in the BER across any two consecutive points in the path.

In the previous description, the isolation of the soft faults is envisioned as an entirely reactive system. Namely, the failure occurs, a TCA is posted, and a short time later the OCh trail, OMS and OTS trails are analized for locating the shortest segment. However, the system of the invention may also be implemented as a proactive system that attempts to isolate failures before they affect the customer. The result could be posted as an indication of deterioration in Q before any other indications exist. Or the fault isolation system may simply hold on to the information to speed up isolation in the event that a threshold is crossed.

An end-to-end connection may consist of two or more trails, with one or more regenerations or wavelength translations. Bit errors left over after FEC correction become part of the next leg's payload, i.e. regeneration treats the faulty output of a previous section as normal data. It follows that a TCA at any receiver is a fault for that trail only. But is it possible to accumulate post-FEC bit errors across multiple optical legs, resulting in unacceptable payload quality at egress from the network without any TCAs to start the fault isolation process. Nonetheless, the OCh-FD monitors this situation and raises its own TCAs for the whole path. This feature requires careful selection of BER thresholds (e.g. the raw BER must hover just above 7×10⁻³ in order to allow a few post-FEC bit errors into the payload. But it cannot go higher, since that quickly leads to LOF). As well, the post-FEC must be set a bit above 1×10⁻¹⁵, allowing a few bit errors to slip through each section. On the other hand, each of these unlikely scenarios must exist for all segments, further reducing the likelihood that a full-path BER problem can exist without triggering a TCA on a trail.

Hard Fault Isolation

Hard faults in the transmission path are readily detected since there is a loss of continuity, which can easily be detected at the Och endpoints. In a transparent network a fiber span will contain wavelengths that ingress and egress the network at different nodes, causing several network elements to detect the loss of signal condition. To avoid superfluous alarm reports at connection termination points the fault management system provides fault indications to downstream nodes in a manner similar to SONET. This is accomplished by sending Forward Defect Indications (FDI) over the optical supervisory channel (OSC), as defined in ITU G.872. In addition, the fault management system requires knowledge of the network topology and relationship between OMS and Och layers to condition downstream alarms.

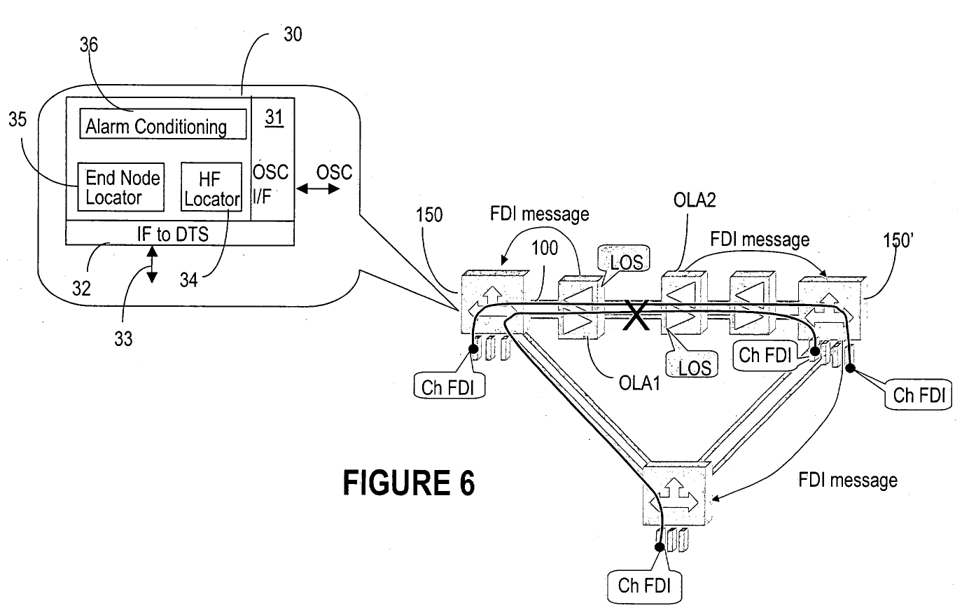

For example, as shown in FIG. 6, alarm indications in the event of a fiber cut can be conditioned so that the root cause can be quickly detected. In the event of a fiber cut, the line amplifiers OLA1 and OLA2 adjacent to the cut send FDI messages over the service channel OSC to the nearest downstream nodes 150,150′ indicating a failure. Using the DTS, the switching nodes determine the end points of all affected connections and, in-turn, send FDI messages to the endpoint network elements. When the FDI indication is received, the channel loss of signal can be conditioned (converted) to a lower severity alarm at the endpoints. This provides a clear alarm indication of the root cause at the amplifier sites and an indication of affected channels at the endpoints.

FIG. 6 also illustrates a block diagram of the hard fault monitor HFM 30. As described above, HFM 30 is provided on each node 150, 150′ and comprises an OSC interface 31 that identifies which amplifiers generated the FDI message. A DTS interface 32 established over an internal signaling and control network 33 collects the information about the end points of all channels on the affected fiber. The hard fault locator 34 identifies which fiber section is interrupted, by identifying the respective OLA1 (for the HFM 30 at node 150) or OLA2 that sent the respective FDI message. If fiber 100 carries for example channels 1, 2, 5 and 7, end node locator 35 uses the topology data identifying the trail of these channels and determines the end nodes for each channel 1, 2, 5 and 7. The alarm conditioning unit 36 conditions the LOS sent to all these end nodes to a lower severity.

In conclusion, faults isolation in an agile transparent network can be made simple for the network operator. ITU-T Recommendations define network layering and maintenance messaging that provides hard fault isolation capabilities equivalent to those found in SONET. Techniques and tools for isolating soft faults in an agile transparent network improve upon existing point-to-point DWDM implementations. Optical eavesdropping provides an equivalent to monitoring at OEO conversion points. The improvements come from a distributed control plane with network topology awareness, increased photonic monitoring, embedded optical component performance information and intelligent fault isolation tools that automate data collection and analysis.

We claim:

1. In an optical agile network having a plurality of switching nodes connected over optical fiber links, said network being provided with a distributed topology system DTS that maintains an updated view of network topology and performance, a fault isolation system for determining a point of failure along an optical channel Och trail in said network, comprising:
at an egress terminal of said optical channel Och trail, means for detecting one of a signal degradation indication and loss of signal indication, whenever the user signal carried by said channel is subject to a fault; and
an optical channel fault detector Och-FD for isolating an optical multiplex section OMS that produced said fault.

2. A fault isolation system as claimed in claim 1, further comprising and optical multiplex section fault detector OMS-FD controlled by said Och-FD for isolating said fault to an optical transport section OTS and to a segment of said OTS.

3. A fault isolation system location as claimed in claim 1, wherein said optical channel fault detector comprises a plurality of optical eavesdropping monitors OEMs, connected at the input side of each switching node along said Och trail for determining a faulted optical multiplex section by comparing a performance parameter measured by each said OEM with an expected performance parameter.

4. A fault isolation system location as claimed in claim 2, wherein each said optical eavesdropping monitor comprises:
a monitoring tap for separating a fraction of a WDM signal at said input side;
a receiver for OE converting said channel and determining said performance parameter;
an optical wavelength selector for routing said channel from said monitoring tap to said receiver; and
a controller for tuning said optical wavelength selector on said channel upon receipt of said signal degraded indication.

5. A fault isolation system as claimed in claim 4, wherein said receiver is one of a network receiver that is allocated to said fault monitoring system and a receiver dedicated to fault detection.

6. A fault isolation system as claimed in claim 4, wherein said receiver is equipped with digital wrapper capabilities and with means for rising a threshold crossing alert whenever the BER information carried by said digital wrapper crosses a threshold, for detecting a failed optical multiplex section OMS.

7. A fault isolation system as claimed in claim 2, further comprising an advanced fault correlation AFC tool for localizing a failed optical transport section OTS of said OMS by correlating all current OMS performance data with the corresponding historical OMS performance data for all OTSs of said failed OMS.

8. A fault isolation system as claimed in claim 7, wherein said AFC tool comprises:
means for obtaining current performance data from one or more monitoring points provided along each said OTS of said failed OMS;
an interface with said distributed topology system for accessing all historical performance data corresponding to said monitoring points;
means for evaluating expected performance data from said historical performance data and correlating said current performance data with said expected data to detect said failed OTS.

9. A fault isolation system as claimed in claim 3, wherein said optical wavelength selector is a tunable filter.

10. In an optical network having a plurality of switching nodes connected over optical fiber links, said network being provided with a distributed topology system DTS that maintains an updated view of network topology and performance data, a fault isolation system for determining a point of failure along an optical channel Och trail in said network, comprising:
at an optical amplifier site, means for detecting an upstream loss of signal alarm LOS and transmitting a forward defect indication FDI;
at a first switching node downstream from said optical amplifier, a hard fault monitor for locating a fault that triggered said loss of signal LOS indication.

11. A fault isolation system as claimed in claim 10, wherein said hard fault monitor comprises:
an interface with an optical supervisory channel OSC for receiving said forward defect indication FDI;
an interface with a distributed topology system DTS for determining all channels co-propagating on said faulted optical multiplex section, and all associated optical channel egress terminals;
means for identifying a faulted optical multiplex section that generated said LOS alarm and transmitting an FDI to said egress terminals over said OSC interface;
alarm conditioning means for receiving said FDI and reclassifying said LOS alarm as a lower severity alarm.

12. A method for fault isolation in optical networks of the type having a distributed topology system DTS that maintains an updated view of network topology and performance data, comprising:
collecting on-line performance data at optical device granularity from performance measurement points provided throughout said network;
identifying a fault in said network;
filtering said on-line performance data for said channel trail to provide filtered performance data pertinent to said fault; and
isolating said fault based on said filtered data.

13. A method as claimed in claim 12, wherein said step of identifying a fault comprises:
identifying an optical channel trail affected by said fault;
identifying all optical multiplex sections along said optical channel trail and calculating an estimated performance parameter for each said section;
optical eavesdropping for determining for each said section a current performance parameter; and
comparing said estimated performance parameter with said current performance parameter to determine a faulted OMS.

14. A method as claimed in claim 13, wherein said identifying an optical channel implies detecting a threshold crossing alert at the egress receiver.

15. A method as claimed in claim 13, wherein said optical eavesdropping is performed on a taped fraction of an optical multiplex signal at the output of said faulted OMS.

16. A method as claimed in claim 13, wherein said current and estimated performance parameter is signal BER.

17. A method as claimed in claim 13, wherein said step of identifying a fault further comprises, for each OMS of said faulted Och trail:
obtaining all available historical performance data pertinent to each matching performance measurement points;
obtaining all recent call set-ups and threshold changes pertinent to each said OMS; and
isolating said fault to a shortest possible segment of said faulted OMS.

18. A method as claimed in claim 17, wherein step of isolating said fault to a shortest possible segment of said faulted OMS comprises juxtaposing, contrasting and comparing said current said historical performance data, said recent thresholds and said recent call set-ups.

19. A method as claimed in claim 13, further comprising running direct tests on all optical devices of said faulted OMS, without changing on the operation of said optical channel trail, to further isolate.

20. A method as claimed in claim 12, further comprising identifying an optical channel trail affected by said problem and halting said filtering step whenever a hard fault is detected on said optical channel trail.

21. A method as claimed in claim 12, further comprising identifying a channel trail affected by said problem and converting said filtered data for presenting on a graphical user interface said channel trail with an indication on a faulted section and said faulted optical device.
